(19) United States
(12) Patent Application Publication
(10) Pub. No.: US 2024/0233334 A1
(43) Pub. Date: Jul. 11, 2024

(54) MULTI-MODAL DATA RETRIEVAL METHOD AND APPARATUS, MEDIUM, AND ELECTRONIC DEVICE

(71) Applicant: Beijing Youzhuju Network Technology Co., Ltd., Beijing (CN)

(72) Inventors: Jin XIA, Beijing (CN); Keyu WEN, Beijing (CN); Yuanyuan HUANG, Beijing (CN); Jie SHAO, Beijing (CN); Changhu WANG, Beijing (CN)

(21) Appl. No.: 18/563,222

(22) PCT Filed: Apr. 26, 2022
(86) PCT No.: PCT/CN2022/089241

§ 371 Date: Nov. 21, 2023

(30) Foreign Application Priority Data
May 25, 2021 (CN) 202110573402.0

(51) Int. Cl. G06V 10/77; G06T 5/60; G06V 10/82

(52) U.S. Cl. CPC G06V 10/7715; G06T 5/60; G06V 10/82

(57) ABSTRACT

The present disclosure relates to a multi-modal data retrieval method and apparatus, a medium, and an electronic device. The method includes: inputting target retrieval data into a first feature extraction network corresponding to a modality of the target retrieval data to acquire a data feature of the target retrieval data; inputting the data feature into a second feature extraction network corresponding to the modality of the target retrieval data to acquire a target retrieval feature corresponding to the target retrieval data, wherein second feature extraction networks respectively corresponding to modalities share a weight; and performing retrieval based on the target retrieval feature.

### CROSS REFERENCE TO RELATED APPLICATIONS

The present application claims priority to Chinese Patent Application No. 202110573402.0, filed on May 25, 2021 and entitled “MULTI-MODAL DATA RETRIEVAL METHOD AND APPARATUS, MEDIUM, AND ELECTRONIC DEVICE”, which is incorporated herein by reference in its entirety.

### TECHNICAL FIELD

The present disclosure relates to the field of data processing, and more particularly, to a multi-modal data retrieval method and apparatus, a medium, and an electronic device.

### BACKGROUND

Content-based multi-modal matching technology has a large number of application scenarios in Internet services, including but not limited to image retrieval (for example, searching for an image by an image), cross-modal retrieval (for example, searching for a text by a text, searching for a text by an image, and searching for a video by a text), and text matching (searching for a text by a text). In order to obtain better matching accuracy, in the case of handling cross-modal retrieval tasks, it is necessary to splice data having different modalities as input of a network model and extract a data feature of the spliced data before performing cross-modal retrieval in the related art, which is very inefficient in practical applications and may not meet the speed requirements in real scenarios.

### SUMMARY

This summary section is provided in order to simply present the ideas which will be described in detail hereinafter in the detailed description section. The summary section is not intended to identify key features or essential features of the claimed technical solutions, nor is it intended to limit the scope of the claimed technical solutions.

In a first aspect, the present disclosure provides a multi-modal data retrieval method. The method includes: inputting target retrieval data into a first feature extraction network corresponding to a modality of the target retrieval data to acquire a data feature of the target retrieval data; inputting the data feature into a second feature extraction network corresponding to the modality of the target retrieval data to acquire a target retrieval feature corresponding to the target retrieval data, wherein second feature extraction networks respectively corresponding to modalities shares a weight; and performing retrieval based on the target retrieval feature.

In a second aspect, the present disclosure provides a multi-modal data retrieval apparatus. The apparatus includes: a first processing module configured to input target retrieval data into a first feature extraction network corresponding to a modality of the target retrieval data to acquire a data feature of the target retrieval data; a second processing module configured to input the data feature into a second feature extraction network corresponding to the modality of the target retrieval data to acquire a target retrieval feature corresponding to the target retrieval data, wherein second feature extraction networks respectively corresponding to modalities share a weight; and a retrieval module configured to perform retrieval based on the target retrieval feature.

In a third aspect, the present disclosure provides a computer-readable medium having a computer program stored thereon. The program, when executed by a processing unit, implements steps of the method in the first aspect.

In a fourth aspect, the present disclosure provides an electronic device. The electronic device includes: a storage unit having a computer program stored thereon; and a processing unit configured to execute the computer program in the storage unit, to implement steps of the method in the first aspect.

With the above technical solutions, the target retrieval feature that is more suitable for multi-modal retrieval may be extracted by the first feature extraction networks and the second feature extraction networks corresponding to data having different modalities respectively. In addition, as the second feature extraction networks of the modalities share the weight, the number of parameters used in the whole network model may be compressed, the structure of the network model is optimized, to improve the training efficiency of the network model, and moreover, the retrieval accuracy in a retrieval task of either single-modal retrieval or cross-modal retrieval of any modality is also improved.

Other features and advantages of the present disclosure will be described in detail in the subsequent detailed description.

### BRIEF DESCRIPTION OF DRAWINGS

The above and other features, advantages and aspects of embodiments of the present disclosure will become more apparent in conjunction with the accompanying drawings and with reference to the following detailed description. Throughout the accompanying drawings, identical or similar reference numerals indicate identical or similar elements. It is to be understood that the accompanying drawings are schematic and that the components and elements are not necessarily drawn to scale. In the figures:

FIG. 1 is a flow diagram of a multi-modal data retrieval method according to an exemplary embodiment of the present disclosure.

FIG. 2 is a flow diagram of pre-training for a first feature extraction network and a second feature extraction network in a multi-modal data retrieval method according to another exemplary embodiment of the present disclosure.

FIG. 3 shows a multi-modal retrieval network model including the first feature extraction network and the second feature extraction network.

FIG. 4 is a flow diagram of pre-training for a first feature extraction network and a second feature extraction network in a multi-modal data retrieval method according to still another exemplary embodiment of the present disclosure.

FIG. 5 is a flow diagram of pre-training for a first feature extraction network and a second feature extraction network in a multi-modal data retrieval method according to still another exemplary embodiment of the present disclosure.

FIG. 6 is a flow diagram of a multi-modal data retrieval method according to still another exemplary embodiment of the present disclosure.

FIG. 7 is a structural block diagram of a multi-modal data retrieval apparatus according to an exemplary embodiment of the present disclosure.

FIG. 8 is a structural block diagram of a multi-modal data retrieval apparatus according to another exemplary embodiment of the present disclosure.

FIG. 9 shows a schematic structural diagram of an electronic device adapted to implement the embodiments of the present disclosure.

### DESCRIPTION OF EMBODIMENTS

Embodiments of the present disclosure will be described in more detail below with reference to the accompanying drawings. While some embodiments of the present disclosure are shown in the accompanying drawings, it is to be understood that the present disclosure can be implemented in various forms and should not be construed as being limited to the embodiments set forth herein; rather, these embodiments are provided for a more thorough and complete understanding of the present disclosure. It is to be understood that the accompanying drawings and embodiments of the present disclosure are merely for exemplary purposes and are not intended to limit the scope of protection of the present disclosure.

It is to be understood that the individual steps cited in the method embodiments of the present disclosure may be performed in a different order, and/or in parallel. In addition, the method embodiments may include additional steps and/or omit the steps illustrated. The scope of the present disclosure is not limited in this regard.

As used herein, the term “include” and variations thereof are open-ended, i.e., “includes but is not limited to”. The term “based on” is “based, at least in part, on”. The term “an embodiment” indicates “at least one embodiment”; the term “another embodiment” indicates “at least one additional embodiment”; and the term “some embodiments” indicates “at least some embodiments”. Relevant definitions of other terms will be given in the description below.

It is to be noted that the concepts “first”, “second” and the like mentioned in the present disclosure are used merely to distinguish different apparatuses, modules or units, and are not intended to define the order or interdependence of the functions performed by these apparatuses, modules or units.

It is to be noted that the modifications of “one” and “a plurality of” mentioned in the present disclosure are illustrative and not restrictive, and it is to be understood by those skilled in the art that they should be understood as “one or more” unless otherwise expressly stated in the context.

The names of messages or information interacted between a plurality of apparatuses in the implementations of the present disclosure are for illustrative purposes merely and are not intended to limit the scope of these messages or information.

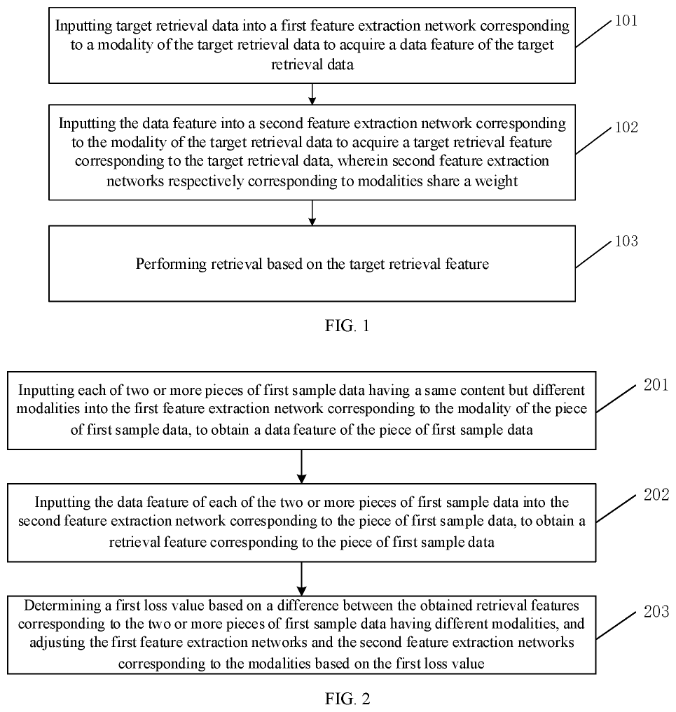

FIG. 1 is a flow diagram of a multi-modal data retrieval method according to an exemplary embodiment of the present disclosure. As shown in FIG. 1, the method includes steps 101 to 103.

In step 101, target retrieval data is inputted into a first feature extraction network corresponding to a modality of the target retrieval data to acquire a data feature of the target retrieval data.

In step 102, the data feature is inputted into a second feature extraction network corresponding to the modality of the target retrieval data to acquire a target retrieval feature corresponding to the target retrieval data. Here, second feature extraction networks respectively corresponding to modalities share a weight.

In step 103, retrieval is performed based on the target retrieval feature.

The modality of the target retrieval data may be any modality, and to-be-retrieved data may also be any modality. The modality may include, for example, a text modality, an image modality, and a video modality, etc. For example, the target retrieval data may be data having the image modality, and the to-be-retrieved data is data having the text modality; or the target retrieval data may be data having the text modality, and the to-be-retrieved data is data having the image modality. In this case, the data retrieval is cross-modal retrieval, that is, data that is most similar to the data having one modality is retrieved from the to-be-retrieved data having another modality. Alternatively, the target retrieval data is data having the image in modality, and the to-be-retrieved data may also be data having the image modality; or, the target retrieval data is data having the text modality, and the to-be-retrieved data is also the data having the text modality. In this case, the data retrieval is single-modal retrieval. Whether the target retrieval data has the same modality as or different modality from the to-be-retrieved data, retrieval can be performed through the present disclosure. The actual content of the target retrieval data and the to-be-retrieved data may be determined in real time based on specific retrieval tasks.

The first feature extraction network may be one of one or more feature extraction networks that are capable of performing data feature extraction on data having different modalities respectively. For example, a text feature extraction network configured to perform feature extraction on data having the text modality may be the first feature extraction network, or a visual feature extraction network configured to perform feature extraction on data having the image modality may be the first feature extraction network. Any network capable of performing feature extraction on the target retrieval data may be used as the first feature extraction network.

The specific content of the first feature extraction network is related to the modality of the target retrieval data. For example, if the modality of the target retrieval data is the text modality, the first feature extraction network may be selected as a text feature extraction network configured to perform text feature extraction on data having the text modality. If the modality of the target retrieval data is the image modality, the first feature extraction network may be selected as a visual feature extraction network configured to perform image feature extraction on data having the image modality.

The second feature extraction network is configured to perform further extraction on the data feature acquired from the first feature extraction network to obtain the target retrieval feature. Input data and output data of the second feature extraction network have the same dimensions, and after an output matrix is pooled, the target retrieval feature may be obtained. Since each modality has the corresponding second feature extraction network and the second feature extraction networks corresponding to the modalities share a weight, that is, representations learned respectively during the training of the second feature extraction network corresponding to each modality can be taken into account, the second feature extraction network may learn common representations having the consistent modality no matter what modality the second feature extraction network corresponds to. Thus, better target retrieval features may be extracted for retrieval in the case of cross-modal retrieval, and moreover, better retrieval accuracy may be achieved in a retrieval task of single-modal retrieval.

After the target retrieval feature corresponding to the target retrieval data is acquired through the first feature extraction network and the second feature extraction network, the corresponding first feature extraction network and second feature extraction network may be determined respectively based on the modality of the to-be-retrieved data during the retrieval of the target retrieval data, to obtain retrieval features corresponding to the to-be-retrieved data. In this way, the obtained target retrieval feature and the retrieval features of the to-be-retrieved data may have better retrieval accuracy there between.

In one possible implementation, the performing retrieval based on the target retrieval feature may be retrieving the target retrieval data in a retrieval database based on the target retrieval feature. The retrieval database may be determined based on an actual retrieval task. If the actual retrieval task is single-modal retrieval for the text modality, to-be-retrieved data included in the selected retrieval database may all be data having the text modality. If the actual retrieval task is to perform retrieval in the to-be-retrieved data having the image modality based on the target retrieval data having the text modality, to-be-retrieved data included in the retrieval database may all be data having the image modality. In addition, the retrieval database may include the above to-be-retrieved data, or may directly include the retrieval features corresponding to the to-be-retrieved data, or may include both the to-be-retrieved data and the retrieval features corresponding to the to-be-retrieved data. In the case that the retrieval database directly includes the retrieval features corresponding to the to-be-retrieved data, the retrieval features in the retrieval database may also be acquired through the first feature extraction network and the second feature extraction network corresponding to the modality of the to-be-retrieved data.

In the retrieval process, the similarity between the target retrieval feature and the retrieval feature of each piece of the to-be-retrieved data may be calculated respectively, and sorted. The data with a high similarity is target data semantically similar to the target retrieval data.

With the above technical solutions, the target retrieval feature that is more suitable for multi-modal retrieval may be extracted by the first feature extraction networks and the second feature extraction networks corresponding to data having different modalities respectively. In addition, as the second feature extraction networks of the modalities share the weight, the number of parameters used in the whole network model may be compressed, the structure of the network model is optimized, to improve the training efficiency of the network model, and moreover, the retrieval accuracy in a retrieval task of either single-modal retrieval or cross-modal retrieval of any modality is also improved.

FIG. 2 is a flow diagram of pre-training for the first feature extraction network and the second feature extraction network in the multi-modal data retrieval method according to another exemplary embodiment of the present disclosure. The first feature extraction network and the second feature extraction network are obtained by pre-training. Pre-training is performed simultaneously for the first feature extraction network and the second feature extraction network. As shown in FIG. 2, the pre-training includes steps 201 to 203.

In step 201, each of two or more pieces of first sample data having the same content but different modalities is inputted into the first feature extraction network corresponding to the modality of the piece of first sample data, to obtain a data feature of the piece of first sample data.

In step 202, the data feature of each of the two or more pieces of first sample data is inputted into the second feature extraction network corresponding to the piece of first sample data, to obtain a retrieval feature corresponding to the piece of first sample data.

In step 203, a first loss value is determined based on a difference between the obtained retrieval features corresponding to the two or more pieces of first sample data having different modalities, and the first feature extraction networks and the second feature extraction networks corresponding to the modalities are adjusted based on the first loss value.

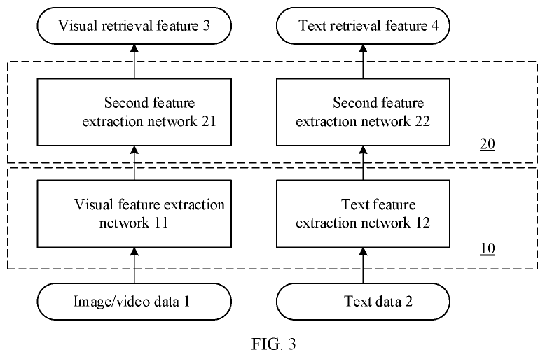

FIG. 3 shows a multi-modal retrieval network model including the first feature extraction network and the second feature extraction network. As shown in FIG. 3, the whole network model includes the first feature extraction network 10 and the second feature extraction network 20. FIG. 3 further exemplarily shows the visual feature extraction network 11 and the text feature extraction network 12 that may be included in the first feature extraction network 10, a second feature extraction network 21 corresponding to the image modality, and a second feature extraction network 22 corresponding to the text modality. The data feature of data having the image modality, such as image or video data 1, may be acquired through the visual feature extraction network 11, and the data feature is inputted into the second feature extraction network 21 corresponding to the image modality for further feature extraction, to obtain a final visual retrieval feature 3. Text data 2 may be inputted into the text feature extraction network 12 to acquire the data feature, and the data feature is inputted into the second feature extraction network 22 corresponding to the text modality for further feature extraction, to obtain a final text retrieval feature 4.

The pre-training shown in FIG. 2 is described below through the exemplary network model shown in FIG. 3. The first sample data includes a piece of text data with a data content of “small dog” and a piece of image data with a data content of “small dog”. In this case, the piece of text data may be inputted into the text feature extraction network 12 to acquire the data feature, and then the acquired data feature is inputted into the second feature extraction network 22 to acquire the text retrieval feature 4 corresponding to the text data; and the piece of image data is inputted into the visual feature extraction network 11 to acquire the data feature, and then the data feature is inputted into the second feature extraction network 21 to acquire the visual retrieval feature 3 corresponding to the image data. Finally, the first loss value is determined based on the difference between the retrieval features corresponding to the two pieces of sample data, and the parameters in the text feature extraction network 12, the visual feature extraction network 11, the second feature extraction network 22, and the second feature extraction network 21 corresponding to the modalities are adjusted based on the first loss value. Therefore, the first feature extraction networks and the second feature extraction networks corresponding to different modalities are pre-trained by comparative learning of the data having different modalities.

With the above technical solutions, the first feature extraction networks and the second feature extraction networks may be pre-trained simultaneously based on the first sample data having different modalities but the same content, so that the first feature extraction networks and second feature extraction networks may learn relevant semantic representations of the data having different modalities, and accordingly, the extracted retrieval features focus more on the content meaning of the data, thereby reducing the influence of the data modalities on the retrieval feature data and improving the accuracy of cross-modal retrieval.

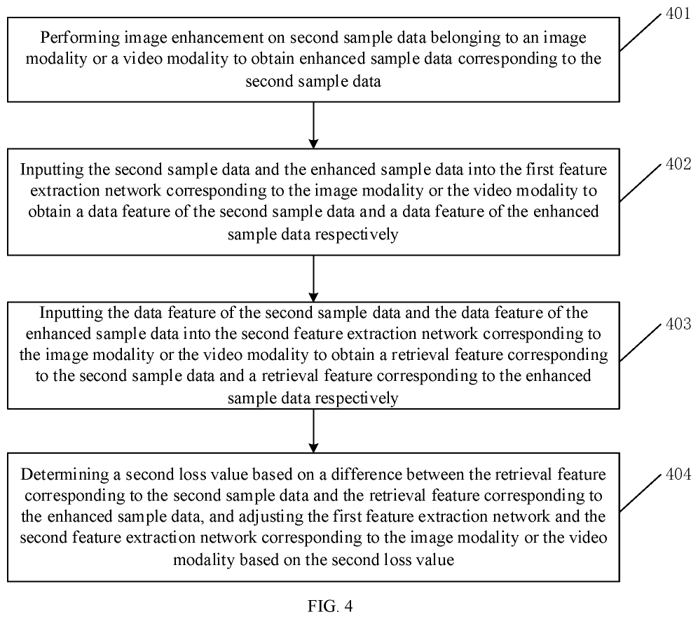

FIG. 4 is a flow diagram of pre-training for the first feature extraction network and the second feature extraction network in the multi-modal data retrieval method according to still another exemplary embodiment of the present disclosure. As shown in FIG. 4, the pre-training further includes steps 401 to 404.

In step 401, image enhancement is performed on second sample data belonging to the image modality or the video modality to obtain enhanced sample data corresponding to the second sample data. The image enhancement may be carried out in any way, which is not limited by the present disclosure.

In step 402, the second sample data and the enhanced sample data are inputted into the first feature extraction network corresponding to the image modality or the video modality to obtain a data feature of the second sample data and a data feature of the enhanced sample data respectively.

In step 403, the data feature of the second sample data and the data feature of the enhanced sample data are inputted into the second feature extraction network corresponding to the image modality or the video modality to obtain a retrieval feature corresponding to the second sample data and a retrieval feature corresponding to the enhanced sample data respectively.

In step 404, a second loss value is determined based on a difference between the retrieval feature corresponding to the second sample data and the retrieval feature corresponding to the enhanced sample data, and the first feature extraction network and the second feature extraction network corresponding to the image modality or the video modality are adjusted based on the second loss value.

That is, the pre-training further includes image self-supervised pre-training for the first feature extraction network and the second feature extraction network corresponding to the image modality or the video modality, that is, training for single-modal retrieval, which may ensure the retrieval accuracy of the first feature extraction network and the second feature extraction network for single-modal data to a certain extent. In addition, as the second feature extraction networks corresponding to the modalities share the weight, the second feature extraction networks may better learn the different semantic representations of each modality, which may also improve the accuracy of cross-modal retrieval to a certain extent.

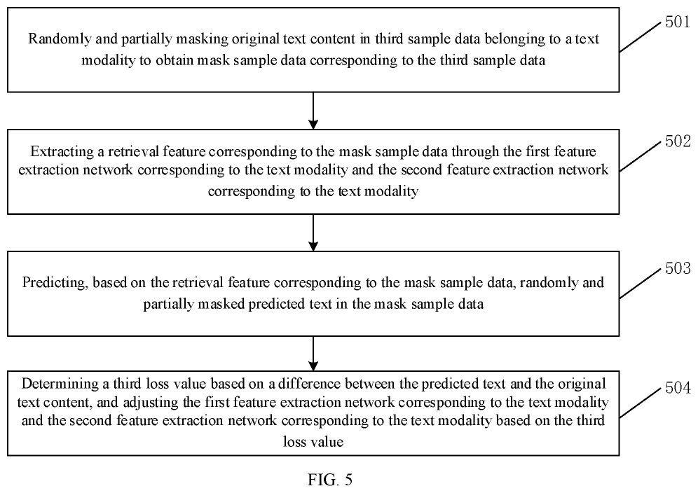

FIG. 5 is a flow diagram of pre-training for the first feature extraction network and the second feature extraction network in the multi-modal data retrieval method according to yet still another exemplary embodiment of the present disclosure. As shown in FIG. 5, the pre-training further includes steps 501 to 504.

In step 501, original text content in third sample data belonging to the text modality are randomly and partially masked to obtain mask sample data corresponding to the third sample data.

In step 502, a retrieval feature corresponding to the mask sample data is extracted through the first feature extraction network corresponding to the text modality and the second feature extraction network corresponding to the text modality.

In step 503, randomly and partially masked predicted text in the mask sample data is predicted based on the retrieval feature corresponding to the mask sample data.

In step 504, a third loss value is determined based on a difference between the predicted text and the original text content, and the first feature extraction network corresponding to the text modality and the second feature extraction network corresponding to the text modality are adjusted based on the third loss value.

That is, the pre-training further includes text self-supervised pre-training for the first feature extraction network and the second feature extraction network corresponding to the text modality, that is, another training for single-modal retrieval, which may ensure the retrieval accuracy of the first feature extraction network and the second feature extraction network for single-modal data to a certain extent as the image self-supervised pre-training for the image modality or the video modality does. In addition, as the second feature extraction networks corresponding to the modalities share the weight, the second feature extraction networks may better learn the different semantic representations of each modality, which may also improve the accuracy of cross-modal retrieval to a certain extent.

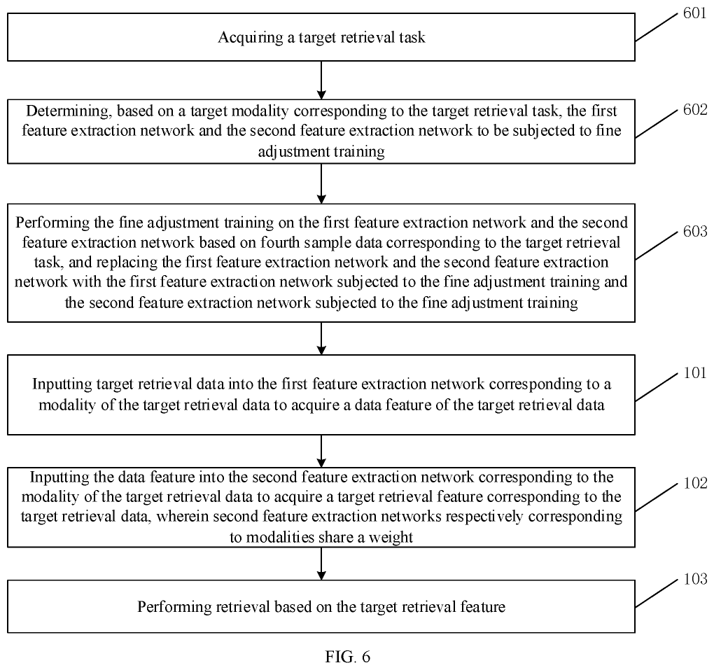

FIG. 6 is a flow diagram of a multi-modal data retrieval method according to another exemplary embodiment of the present disclosure. As shown in FIG. 6, the method further includes steps 601 to 603 prior to step 101.

In step 601, a target retrieval task is acquired.

In step 602, the first feature extraction network and the second feature extraction network to be subjected to fine adjustment training are determined based on a target modality corresponding to the target retrieval task.

In step 603, the fine adjustment training is performed on the first feature extraction network and the second feature extraction network based on fourth sample data corresponding to the target retrieval task, and the first feature extraction network and the second feature extraction network are replaced with the first feature extraction network subjected to the fine adjustment training and the second feature extraction network subjected to the fine adjustment training.

That is, in addition to the above pre-training of the network model, after the target retrieval task is actually acquired, the fine adjustment training may be performed on the first feature extraction network and the second feature extraction network related to the modality corresponding to the target retrieval task, and the first feature extraction network and the second feature extraction network related to the modality corresponding to the target retrieval task are adjusted to the feature extraction networks more suitable for the target retrieval task. For example, if the target retrieval task is a single-modal retrieval task for the text modality, the first feature extraction network and the second feature extraction network corresponding to the text modality may be subjected to fine adjustment training with training data having the text modality, so that the first feature extraction network and the second feature extraction network corresponding to the text modality, for example, the text feature extraction network 12 and the second feature extraction network 22 in FIG. 3, are adjusted. The fine adjustment training based on the training data having the text modality may also be the same as training of the first feature extraction network and the second feature extraction network corresponding to the text modality in the above pre-training process. That is, original text content in the fourth sample data belonging to the text modality is randomly and partially masked to obtain mask sample data corresponding to the fourth sample data; a retrieval feature corresponding to the mask sample data corresponding to the fourth sample data is extracted through the first feature extraction network corresponding to the text modality and the second feature extraction network corresponding to the text modality; randomly and partially masked predicted text in the mask sample data corresponding to the fourth sample data is predicted based on the retrieval feature extracted in the previous step; and a difference between the predicted text and the masked content in the original text content in the fourth sample data is determined as a loss value, and the first feature extraction network and the second feature extraction network corresponding to the text modality are adjusted based on the loss value. Finally, the first feature extraction network and the second feature extraction network subjected to fine adjustment are used for retrieval. The fourth sample data for the fine adjustment training may be independently acquired for the target retrieval task, or may be training data used in the pre-training.

If the target retrieval task is the single-modal retrieval task for the image modality, the first feature extraction network and the second feature extraction network corresponding to the image modality only need to be subjected to the fine adjustment training with the training data having the image modality, so that the first feature extraction network and the second feature extraction network corresponding to the image modality, for example, the visual feature extraction network 11 and the second feature extraction network 21 in FIG. 3, are adjusted. If the target retrieval task is a cross-modal retrieval task between the text modality and the image modality, the first feature extraction networks and the second feature extraction networks corresponding to the image modality and the first feature extraction networks and the second feature extraction networks corresponding to the text modality, for example, the visual feature extraction network 11, the text feature extraction network 12, the second feature extraction network 21, and the second feature extraction network 22 in FIG. 3, need to be subjected to the fine adjustment training at the same time with the training data having the image modality and the text modality.

With the above technical solutions, through the fine adjustment training, the related first feature extraction network and second feature extraction network are further adjusted based on the target retrieval task, so that the first feature extraction network and the second feature extraction network related to the target retrieval task perform better in the target retrieval task, and compared with direct use of the first feature extraction network and the second feature extraction network subjected to pre-training, the retrieval accuracy of the target retrieval task may be further improved.

In one possible implementation, the second feature extraction network is a Transformer model network. In the case that the second feature extraction network is the Transformer model network, the number of blocks for input data having different modalities may be different, for example, the data feature corresponding to the image modality may be 256 blocks, and the data size of the text modality may be 30 blocks. However, in order to ensure that finally obtained data dimensions of data having different modalities are the same, a data dimension outputted by the first feature extraction network corresponding to each modality may be adjusted to ensure that the dimensions of the target retrieval data finally outputted by the second feature extraction network corresponding to each modality may be the same. For example, the visual feature extraction network 11 shown in FIG. 3 may be, for example, a convolutional neural network (CNN), where the input is an image that is uniformly resized to 512*512 in the network, the size of a visual feature map obtained after feature extraction of the network may be, for example, 16*16*2048, which is flattened to 256*2048 and finally mapped to 1024 dimensions through a full connection layer as the output of the network module. The text feature extraction network 12 shown in FIG. 3 may be, for example, a recurrent neural network-based LSTM or GRU, where the input is a piece of text that is encoded as a 768-dimensional vector, and after feature extraction of the network, a 30*768-dimensional text feature is obtained, which is also mapped to 1024 dimensions through the full connection layer and then used as the output of the network module.

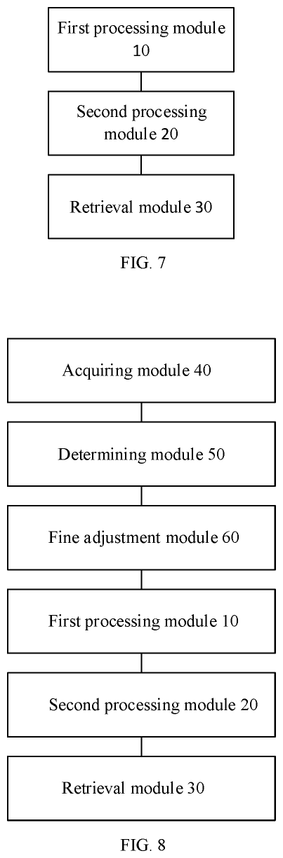

FIG. 7 is a structural block diagram of a multi-modal data retrieval apparatus according to an exemplary embodiment of the present disclosure. As shown in FIG. 7, the apparatus includes: a first processing module 10 configured to input target retrieval data into a first feature extraction network corresponding to a modality of the target retrieval data to acquire a data feature of the target retrieval data; a second processing module 20 configured to input the data feature into a second feature extraction network corresponding to the modality of the target retrieval data to acquire a target retrieval feature corresponding to the target retrieval data, wherein second feature extraction networks respectively corresponding to modalities share a weight; and a retrieval module 30 configured to perform retrieval based on the target retrieval feature.

With the above technical solutions, the target retrieval feature that is more suitable for multi-modal retrieval may be extracted by the first feature extraction networks and the second feature extraction networks corresponding to data having different modalities respectively. In addition, as the second feature extraction networks of the modalities share the weight, the number of parameters used in the whole network model can be compressed, the structure of the network model is optimized, the training efficiency of the network model is improved, and moreover, the retrieval accuracy in a retrieval task of either single-modal retrieval or cross-modal retrieval of any modality is also improved.

In one possible implementation, the first feature extraction network and the second feature extraction network are obtained by pre-training.

In one possible implementation, the pre-training is preformed simultaneously for the first feature extraction network and the second feature extraction network, and the pre-training includes: inputting each of two or more pieces of first sample data having a same content but different modalities into the first feature extraction network corresponding to the modality of the piece of first sample data, to obtain a data feature of the piece of first sample data; inputting the data feature of each of the two or more pieces of first sample data into the second feature extraction network corresponding to the piece of first sample data, to obtain a retrieval feature corresponding to the piece of first sample data; and determining a first loss value based on a difference between the obtained retrieval features corresponding to the two or more pieces of first sample data having different modalities, and adjusting the first feature extraction networks and the second feature extraction networks corresponding to the modalities based on the first loss value.

In one possible implementation, the pre-training further includes: performing image enhancement on second sample data belonging to an image modality or a video modality to obtain enhanced sample data corresponding to the second sample data; inputting the second sample data and the enhanced sample data into the first feature extraction network corresponding to the image modality or the video modality to obtain a data feature of the second sample data and a data feature of the enhanced sample data respectively; inputting the data feature of the second sample data and the data feature of the enhanced sample data into the second feature extraction network corresponding to the image modality or the video modality to obtain a retrieval feature corresponding to the second sample data and a retrieval feature corresponding to the enhanced sample data respectively; and determining a second loss value based on a difference between the retrieval feature corresponding to the second sample data and the retrieval feature corresponding to the enhanced sample data, and adjusting the first feature extraction network and the second feature extraction network corresponding to the image modality or the video modality based on the second loss value.

In one possible implementation, the pre-training further includes: randomly and partially masking original text content in third sample data belonging to a text modality to obtain mask sample data corresponding to the third sample data; extracting a retrieval feature corresponding to the mask sample data through the first feature extraction network corresponding to the text modality and the second feature extraction network corresponding to the text modality; predicting, based on the retrieval feature corresponding to the mask sample data, randomly and partially masked predicted text in the mask sample data; and determining a third loss value based on a difference between the predicted text and the original text content, and adjusting the first feature extraction network corresponding to the text modality and the second feature extraction network corresponding to the text modality based on the third loss value.

FIG. 8 is a structural block diagram of a multi-modal data retrieval apparatus according to another exemplary embodiment of the present disclosure. As shown in FIG. 8, before the first processing module inputs the target retrieval data into the first feature extraction network corresponding to the modality of the target retrieval data to acquire the data feature of the target retrieval data, the apparatus further includes: an acquiring module 40 configured to acquire a target retrieval task; a determining module 50 configured to determine, based on a target modality corresponding to the target retrieval task, the first feature extraction network and the second feature extraction network to be subjected to fine adjustment training; and a fine adjustment module 60 configured to perform the fine adjustment training on the first feature extraction network and the second feature extraction network based on fourth sample data corresponding to the target retrieval task, and replace the first feature extraction network and the second feature extraction network with the first feature extraction network subjected to the fine adjustment training and the second feature extraction network subjected to the fine adjustment training.

In one possible implementation, the retrieval module 30 is further configured to: retrieve the target retrieval data in a retrieval database based on the target retrieval feature. The retrieval database includes to-be-retrieved data and/or a retrieval feature corresponding to the to-be-retrieved data. The retrieval feature corresponding to the to-be-retrieved data is obtained through the first feature extraction network and the second feature extraction network corresponding to the to-be-retrieved data.

In one possible implementation, the second feature extraction network is a Transformer model network.

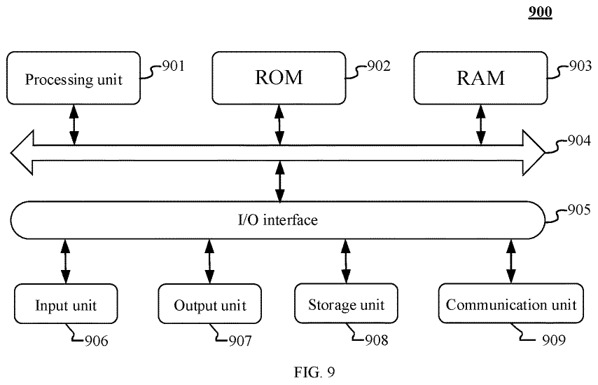

Referring to FIG. 9 below, a schematic structural diagram of an electronic device 900 adapted to implement the embodiments of the present disclosure is illustrated. Terminal devices in the embodiments of the present disclosure may include, but are not limited to, mobile terminals, such as a mobile phone, a laptop, a digit broadcasting receiver, a personal digital assistant (PDA), a tablet computer (PAD), a portable multimedia player (PMP) and a vehicle-mounted terminal (for example, a vehicle-mounted guidance terminal), as well as fixed terminals, such as a digital TV and a desktop computer. The electronic device shown in FIG. 9 is merely an example and should not impose any limitation on the function and scope of usage of the embodiments of the present disclosure.

As shown in FIG. 9, the electronic device 900 may include a processing unit (for example, a central processing unit and a graphics processing unit) 901 that may perform various appropriate actions and processing based on programs stored in a read-only memory (ROM) 902 or programs loaded from a storage unit 908 into a random access memory (RAM) 903. Various programs and data required for operations of the electronic device 900 are also stored in the RAM 903. The processing unit 901, the ROM 902, and the RAM 903 are connected to each other through a bus 904. An input/output (I/O) interface 905 is also connected to the bus 904.

Typically, the following unites may be connected to the I/O interface 905: an input unit 906 including, for example, a touch screen, a touch pad, a keyboard, a mouse, a camera, a microphone, an accelerometer, and a gyroscope; an output unit 907 including, for example, a liquid crystal display (LCD), a speaker, and a vibrator; the storage unit 908 including, for example, a magnetic tape and a hard disk; and a communication unit 909. The communication unit 909 may allow the electronic device 900 to communicate with other devices in a wireless or wired manner to exchange data. Although FIG. 9 illustrates the electronic device 900 with various unites, it is to be understood that it is not required to implement or have all of the unites illustrated. More or fewer unites may alternatively be implemented or provided.

In particular, according to the embodiments of the present disclosure, the process described above with reference to the flow diagrams may be implemented as a computer software program. For example, the embodiments of the present disclosure include a computer program product. The computer program product includes a computer program carried on a non-transitory computer-readable medium. The computer program includes a program code for performing the method shown in the flow diagrams. In the embodiments, the computer program may be downloaded and installed from a network via the communication unit 909, or installed from the storage unit 908, or installed from the ROM 902. When the computer program is executed by the processing unit 901, the above-mentioned functions as defined in the method according to the embodiments of the present disclosure are performed.

It is to be noted that the computer-readable medium described above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination of the above. More specific examples of the computer-readable storage medium may include, but are not limited to: electrical connection via one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic memory device, or any suitable combination of the above. According to the present disclosure, the computer-readable storage medium may be any tangible medium that includes or stores a program, and the program may be used by or in combination with an instruction execution system, apparatus, or device. According to the present disclosure, the computer-readable signal medium may include data signals propagated in a baseband or as part of a carrier wave, in which a computer-readable program code is carried. The propagated data signals may be in a variety of forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit a program for use by or in conjunction with the instruction execution system, apparatus, or device. The program codes included by the computer-readable medium may be transmitted via any suitable medium, including but not limited to: wires, optic cables, radio frequency (RF), etc., or any suitable combination of the above.

In some implementations, a client and a server may implement communication via any currently known or future developed network protocol such as a hypertext transfer protocol (HTTP), and may interconnect with digital data communication (for example, communication networks) of any form or medium. Examples of the communication networks include a local area network (“LAN”), a wide area network (“WAN”), Internet work (for example, the Internet), and an end-to-end network (for example, an ad hoc end-to-end network), as well as any currently known or future developed network.

The above-mentioned computer-readable medium may be included in the above-mentioned electronic device, or be present separately and not fitted into the electronic device.

The computer-readable medium carries one or more programs that, when executed by the electronic device, cause the electronic device to: input target retrieval data into a first feature extraction network corresponding to a modality of the target retrieval data to acquire a data feature of the target retrieval data; input the data feature into a second feature extraction network corresponding to the modality of the target retrieval data to acquire a target retrieval feature corresponding to the target retrieval data, second feature extraction networks respectively corresponding to modalities sharing a weight; and perform retrieval based on the target retrieval feature.

The computer program code for performing the operations of the present disclosure may be written in one or more programming languages or combinations thereof, including, but not limited to, object-oriented programming languages, for example, Java, Smalltalk and C++, and conventional procedural programming languages, for example, “C” language. The program code may be executed entirely on a user computer, partly on a user computer, as a stand-alone software package, partly on a user computer and partly on a remote computer, or entirely on a remote computer or a server. In a case where a remote computer is involved, the remote computer may be connected to a user computer via any kind of networks, including a local area network (LAN) or a wide area network (WAN), or may be connected to an external computer (for example, via the Internet using an Internet service provider).

The flowcharts and the block diagrams in the accompanying drawings illustrate possible implementations of the architecture, functionality, and operation of the system, the method, and the computer program product according to the embodiments of the present disclosure. In this regard, each block in the flowchart or block diagram may represent a module, a program segment, or part of a code, the module, the program segment, or part of the code including one or more executable instructions for implementing specified logical functions. It is also to be noted that in some alternative implementations, the functions noted in the blocks may also occur out of the order noted in the accompanying drawings. For example, two blocks shown in succession may actually be executed in parallel substantially, and sometimes they may also be executed in an inverse order, which depends upon the functionality involved. It is also to be noted that each block in the block diagram and/or flowchart, and the combination of blocks in the block diagram and/or flowchart, may be implemented with a dedicated hardware-based system that performs the specified function or operation, or may be implemented with a combination of dedicated hardware and computer instructions.

The modules described in the embodiments of the present disclosure may be implemented in a software-based manner or may be implemented in a hardware-based manner. The name of a module in some cases does not constitute a limitation on the module itself, for example, a first processing module may also be described as a module configured to input target retrieval data into a first feature extraction network corresponding to a modality of the target retrieval data to acquire a data feature of the target retrieval data.

The functions described above herein may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a systems on chip (SOC), a complex programmable logic device (CPLD), and the like.

In the context of the present disclosure, a machine-readable medium may be a tangible medium that may include or store a program for use by or in connection with the instruction execution system, apparatus or device. The machine-readable medium may be a machine-readable signal medium or a machine-readable storage medium. The machine-readable medium may include but not limited to an electronic, magnetic, optical, electromagnetic, infrared, or semiconductor system, apparatus or device, or any suitable combination of the above contents. More specific examples of the machine-readable storage medium may include electrical connections based on one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

According to one or more embodiments of the present disclosure, Example 1 provides a multi-modal data retrieval method. The method includes: inputting target retrieval data into a first feature extraction network corresponding to a modality of the target retrieval data to acquire a data feature of the target retrieval data; inputting the data feature into a second feature extraction network corresponding to the modality of the target retrieval data to acquire a target retrieval feature corresponding to the target retrieval data, wherein second feature extraction networks respectively corresponding to modalities share a weight; and performing retrieval based on the target retrieval feature.

According to one or more embodiments of the present disclosure, Example 2 provides the method according to Example 1, in which the first feature extraction network and the second feature extraction network are obtained by pre-training.

According to one or more embodiments of the present disclosure, Example 3 provides the method according to Example 2, in which the pre-training is performed simultaneously for the first feature extraction network and the second feature extraction network, and the pre-training includes: inputting each of two or more pieces of first sample data having a same content but different modalities into the first feature extraction network corresponding to the modality of the piece of first sample data, to obtain a data feature of the piece of first sample data; inputting the data feature of each of the two or more pieces of first sample data into the second feature extraction network corresponding to the piece of first sample data, to obtain a retrieval feature corresponding to the piece of first sample data; and determining a first loss value based on a difference between the obtained retrieval features corresponding to the two or more pieces of first sample data having different modalities, and adjusting the first feature extraction networks and the second feature extraction networks corresponding to the modalities based on the first loss value.

According to one or more embodiments of the present disclosure, Example 4 provides the method according to Example 3, in which the pre-training further includes: performing image enhancement on second sample data belonging to an image modality or a video modality to obtain enhanced sample data corresponding to the second sample data; inputting the second sample data and the enhanced sample data into the first feature extraction network corresponding to the image modality or the video modality to obtain a data feature of the second sample data and a data feature of the enhanced sample data respectively; inputting the data feature of the second sample data and the data feature of the enhanced sample data into the second feature extraction network corresponding to the image modality or the video modality to obtain a retrieval feature corresponding to the second sample data and a retrieval feature corresponding to the enhanced sample data respectively; and determining a second loss value based on a difference between the retrieval feature corresponding to the second sample data and the retrieval feature corresponding to the enhanced sample data, and adjusting the first feature extraction network and the second feature extraction network corresponding to the image modality or the video modality based on the second loss value.

According to one or more embodiments of the present disclosure, Example 5 provides the method according to Example 3, in which the pre-training further includes: randomly and partially masking original text content in third sample data belonging to a text modality to obtain mask sample data corresponding to the third sample data; extracting a retrieval feature corresponding to the mask sample data through the first feature extraction network corresponding to the text modality and the second feature extraction network corresponding to the text modality; predicting, based on the retrieval feature corresponding to the mask sample data, randomly and partially masked predicted text in the mask sample data; and determining a third loss value based on a difference between the predicted text and the original text content, and adjusting the first feature extraction network corresponding to the text modality and the second feature extraction network corresponding to the text modality based on the third loss value.

According to one or more embodiments of the present disclosure, Example 6 provides the method according to Example 2, in which the method further includes, prior to the inputting the target retrieval data into the first feature extraction network corresponding to the modality of the target retrieval data to acquire the data feature of the target retrieval data: acquiring a target retrieval task; determining, based on a target modality corresponding to the target retrieval task, the first feature extraction network and the second feature extraction network to be subjected to fine adjustment training; and performing the fine adjustment training on the first feature extraction network and the second feature extraction network based on fourth sample data corresponding to the target retrieval task, and replacing the first feature extraction network and the second feature extraction network with the first feature extraction network subjected to the fine adjustment training and the second feature extraction network subjected to the fine adjustment training.

According to one or more embodiments of the present disclosure, Example 7 provides the method according to any one of Examples 1 to 6, in which the performing retrieval based on the target retrieval feature includes: retrieving the target retrieval data in a retrieval database based on the target retrieval feature, the retrieval database including to-be-retrieved data and/or a retrieval feature corresponding to the to-be-retrieved data, and the retrieval feature corresponding to the to-be-retrieved data being obtained through the first feature extraction network and the second feature extraction network corresponding to the to-be-retrieved data.

According to one or more embodiments of the present disclosure, Example 8 provides the method according to any one of Examples 1 to 6, in which the second feature extraction network is a Transformer model network.

According to one or more embodiments of the present disclosure, Example 9 provides a multi-modal data retrieval apparatus. The apparatus includes: a first processing module configured to input target retrieval data into a first feature extraction network corresponding to a modality of the target retrieval data to acquire a data feature of the target retrieval data; a second processing module configured to input the data feature into a second feature extraction network corresponding to the modality of the target retrieval data to acquire a target retrieval feature corresponding to the target retrieval data, second feature extraction networks respectively corresponding to modalities sharing a weight; and a retrieval module configured to perform retrieval based on the target retrieval feature.

According to one or more embodiments of the present disclosure, Example 10 provides a computer-readable medium having a computer program stored thereon. The program, when executed by a processing unit, implements steps of the method according to any one of Examples 1 to 8.

According to one or more embodiments of the present disclosure, Example 11 provides an electronic device. The electronic device includes: a storage unit having a computer program stored thereon; and a processing unit configured to execute the computer program in the storage unit, to implement steps of the method according to any one of Examples 1 to 8.

The above description is merely a preferred embodiment of the present disclosure and a description of the technical principles applied. It is to be understood by those skilled in the art that the scope of the disclosure covered by the present disclosure is not limited to technical solutions formed by specific combinations of the above technical features, but should also cover other technical solutions formed by any combination of the above technical features or their equivalent features without departing from the above disclosed idea, for example, technical solutions formed by substituting the above features with technical features having similar functions disclosed (but not limited to) in the present disclosure.

In addition, while the operations are depicted in a particular order, it is not to be construed as requiring that the operations be performed in the particular order indicated or in a sequential order. Multitasking and parallel processing may be advantageous in certain environments. Similarly, while a plurality of specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in a plurality of embodiments individually or in any suitable sub-combination.

Although the present subject matter has been described using language specific to structural features and/or method logical actions, it is to be understood that the subject matter as defined in the appended claims is not necessarily limited to the particular features or actions described above. Rather, the particular features and actions described above are merely exemplary forms to implement the claims. As for the apparatus in the above embodiments, the specific manner in which each module performs operations has been described in detail in the method embodiment, which is thus not described in detail here.

1-11. (canceled)

12. A multi-modal data retrieval method, comprising:
inputting target retrieval data into a first feature extraction network corresponding to a modality of the target retrieval data to acquire a data feature of the target retrieval data;
inputting the data feature into a second feature extraction network corresponding to the modality of the target retrieval data to acquire a target retrieval feature corresponding to the target retrieval data, wherein second feature extraction networks respectively corresponding to modalities share a weight; and
performing retrieval based on the target retrieval feature.

13. The method according to claim 12, wherein the first feature extraction network and the second feature extraction network are obtained by pre-training.

14. The method according to claim 13, wherein the pre-training is performed simultaneously for the first feature extraction network and the second feature extraction network, and the pre-training comprises:
inputting each of two or more pieces of first sample data having a same content but different modalities into the first feature extraction network corresponding to the modality of the piece of first sample data, to obtain a data feature of the piece of first sample data;
inputting the data feature of each of the two or more pieces of first sample data into the second feature extraction network corresponding to the piece of first sample data, to obtain a retrieval feature corresponding to the piece of first sample data; and
determining a first loss value based on a difference between the obtained retrieval features corresponding to the two or more pieces of first sample data having different modalities, and adjusting the first feature extraction networks and the second feature extraction networks corresponding to the modalities based on the first loss value.

15. The method according to claim 14, wherein the pre-training further comprises:
performing image enhancement on second sample data belonging to an image modality or a video modality to obtain enhanced sample data corresponding to the second sample data;
inputting the second sample data and the enhanced sample data into the first feature extraction network corresponding to the image modality or the video modality to obtain a data feature of the second sample data and a data feature of the enhanced sample data respectively;
inputting the data feature of the second sample data and the data feature of the enhanced sample data into the second feature extraction network corresponding to the image modality or the video modality to obtain a retrieval feature corresponding to the second sample data and a retrieval feature corresponding to the enhanced sample data respectively; and
determining a second loss value based on a difference between the retrieval feature corresponding to the second sample data and the retrieval feature corresponding to the enhanced sample data, and adjusting the first feature extraction network and the second feature extraction network corresponding to the image modality or the video modality based on the second loss value.

16. The method according to claim 14, wherein the pre-training further comprises:
randomly and partially masking original text content in third sample data belonging to a text modality to obtain mask sample data corresponding to the third sample data;
extracting a retrieval feature corresponding to the mask sample data through the first feature extraction network corresponding to the text modality and the second feature extraction network corresponding to the text modality;
predicting, based on the retrieval feature corresponding to the mask sample data, randomly and partially masked predicted text in the mask sample data; and
determining a third loss value based on a difference between the predicted text and the original text content, and adjusting the first feature extraction network corresponding to the text modality and the second feature extraction network corresponding to the text modality based on the third loss value.

17. The method according to claim 13, wherein the method further comprises, prior to said inputting the target retrieval data into the first feature extraction network corresponding to the modality of the target retrieval data to acquire a data feature of the target retrieval data:
acquiring a target retrieval task;
determining, based on a target modality corresponding to the target retrieval task, the first feature extraction network and the second feature extraction network to be subjected to fine adjustment training; and
performing the fine adjustment training on the first feature extraction network and the second feature extraction network based on fourth sample data corresponding to the target retrieval task, and replacing the first feature extraction network and the second feature extraction network with the first feature extraction network subjected to the fine adjustment training and the second feature extraction network subjected to the fine adjustment training.

18. The method according to claim 12, wherein said performing retrieval based on the target retrieval feature comprises:
retrieving the target retrieval data in a retrieval database based on the target retrieval feature, the retrieval database comprising to-be-retrieved data and/or a retrieval feature corresponding to the to-be-retrieved data, and the retrieval feature corresponding to the to-be-retrieved data being obtained through the first feature extraction network and the second feature extraction network corresponding to the modality of the to-be-retrieved data.

19. The method according to claim 12, wherein the second feature extraction network is a Transformer model network.

20. A non-transitory computer-readable medium having a computer program stored thereon, wherein the program, when executed by a processing unit, implements steps of:
inputting target retrieval data into a first feature extraction network corresponding to a modality of the target retrieval data to acquire a data feature of the target retrieval data;
inputting the data feature into a second feature extraction network corresponding to the modality of the target retrieval data to acquire a target retrieval feature corresponding to the target retrieval data, wherein second feature extraction networks respectively corresponding to modalities share a weight; and
performing retrieval based on the target retrieval feature.

21. The non-transitory computer-readable medium according to claim 20, wherein the first feature extraction network and the second feature extraction network are obtained by pre-training.

22. The non-transitory computer-readable medium according to claim 21, wherein the pre-training is performed simultaneously for the first feature extraction network and the second feature extraction network, and the pre-training comprises:
inputting each of two or more pieces of first sample data having a same content but different modalities into the first feature extraction network corresponding to the modality of the piece of first sample data, to obtain a data feature of the piece of first sample data;
inputting the data feature of each of the two or more pieces of first sample data into the second feature extraction network corresponding to the piece of first sample data, to obtain a retrieval feature corresponding to the piece of first sample data; and
determining a first loss value based on a difference between the obtained retrieval features corresponding to the two or more pieces of first sample data having different modalities, and adjusting the first feature extraction networks and the second feature extraction networks corresponding to the modalities based on the first loss value.

23. The non-transistory computer-readable medium according to claim 22, wherein the pre-training further comprises:
performing image enhancement on second sample data belonging to an image modality or a video modality to obtain enhanced sample data corresponding to the second sample data;
inputting the second sample data and the enhanced sample data into the first feature extraction network corresponding to the image modality or the video modality to obtain a data feature of the second sample data and a data feature of the enhanced sample data respectively;
inputting the data feature of the second sample data and the data feature of the enhanced sample data into the second feature extraction network corresponding to the image modality or the video modality to obtain a retrieval feature corresponding to the second sample data and a retrieval feature corresponding to the enhanced sample data respectively; and
determining a second loss value based on a difference between the retrieval feature corresponding to the second sample data and the retrieval feature corresponding to the enhanced sample data, and adjusting the first feature extraction network and the second feature extraction network corresponding to the image modality or the video modality based on the second loss value.

24. An electronic device, comprising:
a storage unit having a computer program stored thereon; and
a processing unit configured to execute the computer program in the storage apparatus, to implement steps of:
inputting target retrieval data into a first feature extraction network corresponding to a modality of the target retrieval data to acquire a data feature of the target retrieval data;
inputting the data feature into a second feature extraction network corresponding to the modality of the target retrieval data to acquire a target retrieval feature corresponding to the target retrieval data, wherein second feature extraction networks respectively corresponding to modalities share a weight; and
performing retrieval based on the target retrieval feature.

25. The electronic device according to claim 24, wherein the first feature extraction network and the second feature extraction network are obtained by pre-training.

26. The electronic device according to claim 25, wherein the pre-training is performed simultaneously for the first feature extraction network and the second feature extraction network, and the pre-training comprises:
inputting each of two or more pieces of first sample data having a same content but different modalities into the first feature extraction network corresponding to the modality of the piece of first sample data, to obtain a data feature of the piece of first sample data;
inputting the data feature of each of the two or more pieces of first sample data into the second feature extraction network corresponding to the piece of first sample data, to obtain a retrieval feature corresponding to the piece of first sample data; and
determining a first loss value based on a difference between the obtained retrieval features corresponding to the two or more pieces of first sample data having different modalities, and adjusting the first feature extraction networks and the second feature extraction networks corresponding to the modalities based on the first loss value.

27. The electronic device according to claim 26, wherein the pre-training further comprises:
performing image enhancement on second sample data belonging to an image modality or a video modality to obtain enhanced sample data corresponding to the second sample data;
inputting the second sample data and the enhanced sample data into the first feature extraction network corresponding to the image modality or the video modality to obtain a data feature of the second sample data and a data feature of the enhanced sample data respectively;
inputting the data feature of the second sample data and the data feature of the enhanced sample data into the second feature extraction network corresponding to the image modality or the video modality to obtain a retrieval feature corresponding to the second sample data and a retrieval feature corresponding to the enhanced sample data respectively; and
determining a second loss value based on a difference between the retrieval feature corresponding to the second sample data and the retrieval feature corresponding to the enhanced sample data, and adjusting the first feature extraction network and the second feature extraction network corresponding to the image modality or the video modality based on the second loss value.

28. The electronic device according to claim 26, wherein the pre-training further comprises:
randomly and partially masking original text content in third sample data belonging to a text modality to obtain mask sample data corresponding to the third sample data;
extracting a retrieval feature corresponding to the mask sample data through the first feature extraction network corresponding to the text modality and the second feature extraction network corresponding to the text modality;
predicting, based on the retrieval feature corresponding to the mask sample data, randomly and partially masked predicted text in the mask sample data; and
determining a third loss value based on a difference between the predicted text and the original text content, and adjusting the first feature extraction network corresponding to the text modality and the second feature extraction network corresponding to the text modality based on the third loss value.

29. The electronic device according to claim 25, wherein the processing unit is further configured to execute the computer program in the storage apparatus, to implement steps of: prior to said inputting the target retrieval data into the first feature extraction network corresponding to the modality of the target retrieval data to acquire a data feature of the target retrieval data,
acquiring a target retrieval task;
determining, based on a target modality corresponding to the target retrieval task, the first feature extraction network and the second feature extraction network to be subjected to fine adjustment training; and
performing the fine adjustment training on the first feature extraction network and the second feature extraction network based on fourth sample data corresponding to the target retrieval task, and replacing the first feature extraction network and the second feature extraction network with the first feature extraction network subjected to the fine adjustment training and the second feature extraction network subjected to the fine adjustment training.

30. The electronic device according to claim 24, wherein said performing retrieval based on the target retrieval feature comprises:
retrieving the target retrieval data in a retrieval database based on the target retrieval feature, the retrieval database comprising to-be-retrieved data and/or a retrieval feature corresponding to the to-be-retrieved data, and the retrieval feature corresponding to the to-be-retrieved data being obtained through the first feature extraction network and the second feature extraction network corresponding to the modality of the to-be-retrieved data.

31. The electronic device according to claim 24, wherein the second feature extraction network is a Transformer model network.
